(19) United States
(12) Patent Application Publication
(10) Pub. No.: US 2007/0278421 A1
(43) Pub. Date: Dec. 6, 2007

(54) Sample preparation technique

(76) Inventor: K. Reed Gleason, Portland, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 11/789,298

(22) Filed: Apr. 23, 2007

Related U.S. Application Data
(60) Provisional application No. 60/794,711, filed on Apr. 24, 2006.

(51) Int. Cl. G21K 5/10

(52) U.S. Cl. 250/442.11

(57) ABSTRACT

A method of testing a substrate includes separating the substrate from a larger substrate using a separating device and repositioning the substrate to be tested to a processing station apart from the separating device. The substrate is positioned on a holder for inspection.

### CROSS-REFERENCE TO RELATED APPLICATIONS

This application claims the benefit of U.S. Provisional App. No. 60/794,711, filed Apr. 24, 2006.

### BACKGROUND OF THE INVENTION

The present invention relates to a system for separating a sample region from a substrate, such as a semiconductor wafer.

A sample of a semiconductor is cut out of a semiconductor wafer or other object by using a focused ion beam (“FIB”). The sample region is then analyzed, if desired, using a transmission electron microscope (“TEM”), or analyzed by other device.

A conventional technique for preparing a sample for subsequent TEM examination involves separating a chip, or ribbon, having a length typically of several millimeters and a width typically of around 100-500 microns out from a semiconductor. The separation may be performed with a saw. However, the saw has inherent limitations and may result in potential damage to the circuitry itself. The separated chip is mounted on a standard TEM grid within the FIB machine and is then thinned, typically to around 50 microns or less, by using the FIB. Accurate placement of the separated chip on the TEM grid is difficult and time consuming. The thinned sample is then removed from the FIB machine and irradiated with an electron beam for observing by the TEM.

Another conventional technique to prepare a sample for subsequent TEM examination involves using the FIB to cut a sample from a wafer by cutting the sample from at least two different angles after a probe has been attached to the sample. A probe is attached to the sample by using the FIB. The detached sample is manipulated using the attached probe and is attached to a TEM grid by using the FIB. The probe is then removed from the detached sample. It is difficult and time consuming to properly attach the detached sample to the TEM grid using the FIB machine.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates separation of a sample from a wafer.

FIG. 2 illustrates a sample separated from the wafer.

FIG. 3 illustrates a wafer, probe, and positioner.

FIG. 4 illustrates a probe, a wafer, and a microscope.

FIG. 5 illustrates another probe.

FIG. 6 illustrates yet another probe.

FIG. 7 illustrates a TEM grid.

FIG. 8 illustrates a sample holder for examination.

### DETAILED DESCRIPTION OF PREFERRED EMBODIMENT

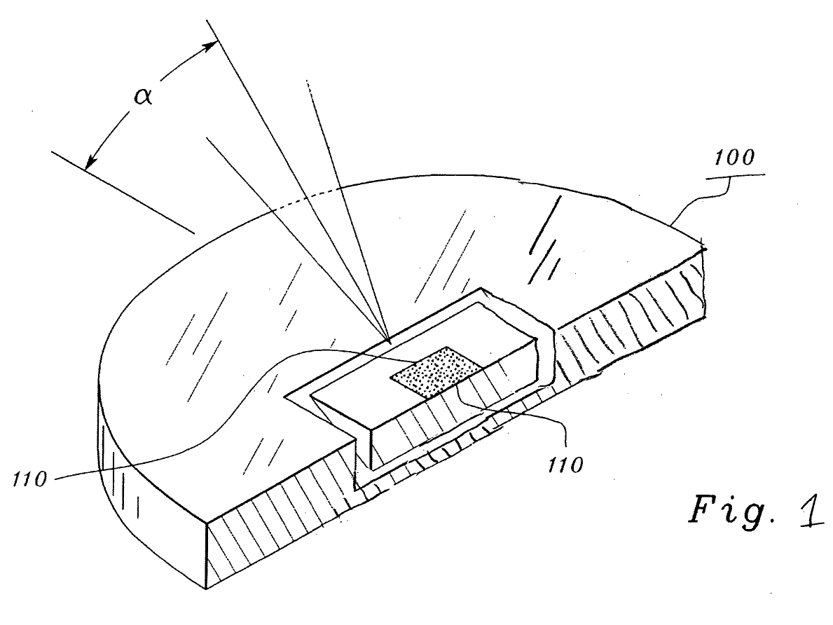

Referring to FIG. 1, a semiconductor wafer 100 has been cleaved or otherwise sawed so that the sample 10 may be removed from the surrounding wafer 100. Preferably, the sample 110 is separated by using a focused ion bean (“FIB”) machine. A separation tool may be used to separate the sample 110 from the wafer. In many cases, the sample 110 has a small portion still retaining it to the wafer until subsequently separated from the wafer.

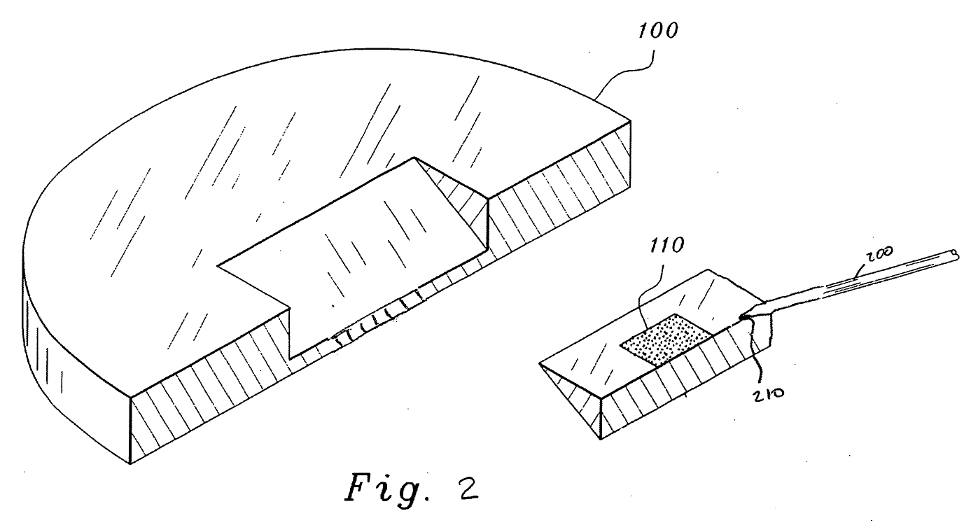

After processing the wafer with the FIB machine, the wafer with one or more partially detached samples 110, may be repositioned to a processing station apart from the FIB machine. The wafer, for example, may be positioned on a chuck or other flat surface. In addition, a positioner with a probe attached thereon may be used for subsequent processing. Referring to FIG. 2, a probe 200 includes a elongate member together with a “sticky” material 210 attached proximate the end thereof. The “sticky” material is preferably selected in such a manner that it effectuates a detachable connection with the surface of the sample 110. One example of a suitable “sticky” material includes silicone. By applying some pressure with the material 210 of the probe 200, the sample 110 will become attached to the material 210 and detached from the sample 110. The probe 200 may be handled, using an automatic handler or manual movement, to reposition the sample 110 in a suitable location. The sample 110 is then removed from the probe 200 by “pealing” it off, or otherwise breaking the seal between the sample 110 and the probe 200.

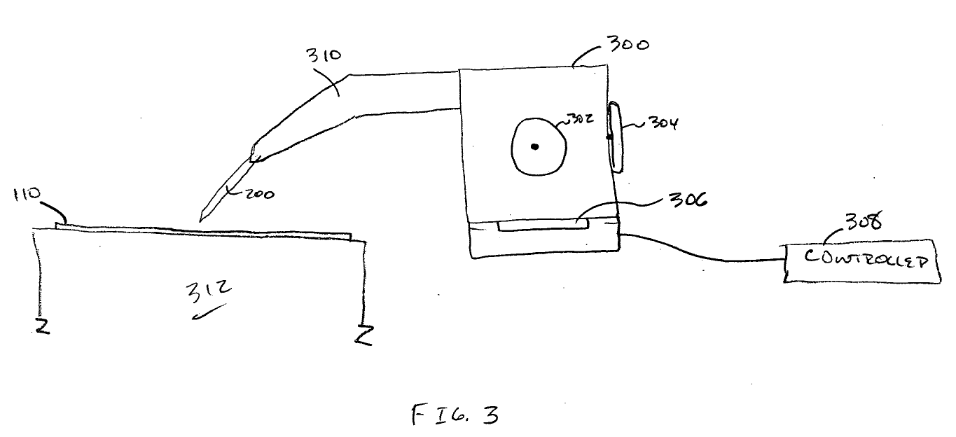

Referring to FIG. 3, the probe 200 may include a positioner 300 that includes the ability to move an arm 310 in an x, y, and z direction. The positioner 300 may include x, y, z manual knobs 302, 304, 306 and/or electrical controller 308 for automated x, y, and z movement. The wafer 110 may be positioned on a chuck 312 or other flat surface.

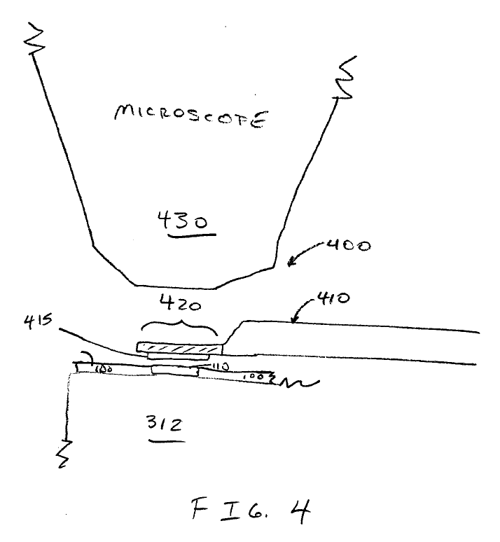

Referring to FIG. 4, an exemplary probe 400 is illustrated. The probe 400 includes an arm 410 that may include a transparent portion 420 at the end thereof together with “sticky” transparent material 415. Preferably the transparent portion 420 is directly above at least a portion of the supported sample 110. In addition, the transparent portion 420 preferably extends beyond the supported sample 110 so that an associated microscope 430 may be readily used to examine the supported sample through the transparent portion 420. In this manner, the probe 400 may be effectively used together with the microscope 430 for the removal of the samples 110.

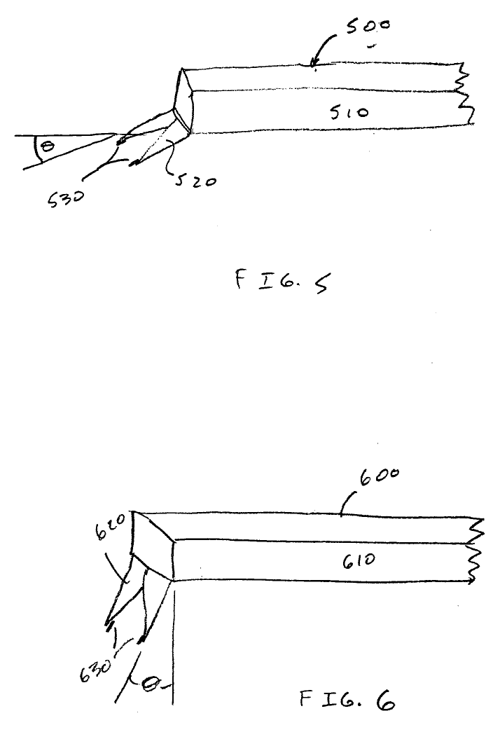

Referring to FIG. 5, another exemplary gripping device 500 for separation of the sample 110 from the wafer 100 includes an elongate handle 510. The elongate handle 510 is suitable for positioning the end of a gripping device 520. In order to facilitate gripping the sample 110 in the vicinity of a microscope observing the sample 110 on the wafer, the elongate handle includes a pair of gripping surfaces 530 that are not in line with the length of the handle 510 nor perpendicular to the length of the handle 510. The gripping surfaces 530 and gripping device 520 are preferably at an angle between 5 degrees and 25 degrees with respect to the length of the gripping device 500.

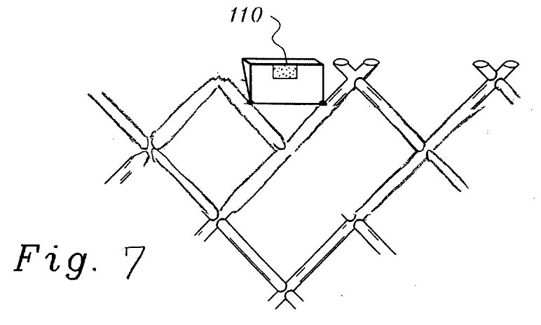

Referring to FIG. 6, another exemplary gripping device 600 includes for separation of the sample 110 from the wafer 100 includes an elongate handle 610. The elongate handle 610 is suitable for positioning the end of a gripping device 620. In order to facilitate gripping the sample 110 in the vicinity of a microscope observing the sample 110 on the wafer, the elongate handle includes a pair of gripping surfaces 630 (e.g., silicon surfaces) that are not in line with the length of the handle 610 nor perpendicular to the length of the handle 610. The gripping surfaces 630 and gripping device 620 are preferably at an angle between 5 degrees and 25 degrees with respect to a perpendicular direction to the length of the gripping device 600.

The preferred technique for examining a sample 110 of a wafer 100 includes the following operations. Initially, the wafer is located in a FIB machine to which one or more samples are at least partially prepared for separation from the wafer. The wafer, including one or more partially prepared samples for separation from the wafer, is removed from the FIB machine. The FIB machine, with is expensive, may be used for other projects after the wafer if removed. The wafer may then be placed on a chuck of a semiconductor probe station, such as those available by Cascade Microtech, Inc. of Beaverton, Oreg. The probe station, together with the combination of a probe and a positioner, may be used to attach the probe to the sample. The attached combination of the probe and sample are then used to separate the sample from the wafer. The separation is performed by exerting a little pressure on the sample 110. The separated sample is then retained by the probe. The separated samples may be positioned on a TEM grid (see FIG. 7), if desired. More preferably, the separated sample is positioned in a holder (described later) that is suitable for subsequent inspection of the sample by the FIB. The separated sample and holder is placed in a TEM device for subsequent inspection. It is noted that frequently the TEM and FIB are in the same device. Typically, a TEM device includes a small FIB to further thin the sample, as desired. In this modified manner of preparing and inspecting a sample for inspection, it may be observed that the FIB is used to partially separate the samples from the wafer. The process of separating the sample from the wafer and positioning the sample on a suitable mounting structure is performed outside of the FIB, which permits the FIB to be used for other purposes during this time.

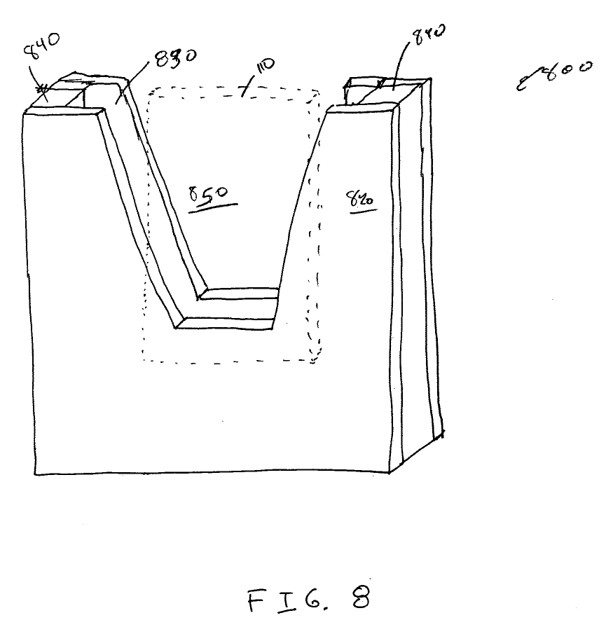

Referring to FIG. 8, a holder 800 for a wafer sample 110 includes an opening 810 into which the sample may be inserted. On both sides of the opening are surfaces 820 and 830 that loosely secure the sample 110 between. Preferably there are vertical side surfaces 840 between the opposing surfaces 820 and 830. In the central region there exists an opening 850 defined by the opposing surfaces 820 and 830. Accordingly, the holder maintains the sample 110 in the holder between the surfaces, in a generally sandwiching arrangement, so that it can be examined. The top surface and the front surface are both available for being thinned by the FIB and likewise for examination by the TEM (or SEM).

It is noted that the “wafer” need not be a semiconductor device. It may, for example, be a micromechanical device or any substance that uses a TEM or SEM analysis, such as particles, granules, biological materials, or thing films. The FIB may be a single beam or a multiple beam model, such as those available from FEI Company of Hillsboro, Oreg.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I claim:

1. A method of testing a substrate comprising:
(a) separating said substrate from a larger substrate using a separating device;
(b) repositioning said substrate to be said tested to a processing station apart from said separating device;
(c) positioning said substrate on a holder for inspection.

2. The method of claim 1 wherein said substrate is separated from a wafer using a focused ion beam.

3. The method of claim 1 wherein said substrate is repositioned to a processing station apart from a focused ion beam device used to separate said substrate from said larger substrate.

4. The method of claim 1 wherein said repositioning is performed with an elongate member detachably attached to said substrate.

5. The method of claim 4 wherein said elongate member includes sticky material at the end thereof.

6. The method of claim 5 wherein said sticky material is silicone.

7. The method of claim 4 wherein said substrate is detached from said large substrate by using said elongate member.

8. The method of claim 1 wherein said substrate is positioned with a controllable positioner.

9. The method of claim 1 wherein said substrate is positioned with a positioner that includes a transparent portion proximate said substrate.

10. The method of claim 9 wherein a microscope is used to inspect said sample through said transparent portion.

11. The method of claim 1 wherein said substrate is positioned with a positioner that includes a gripping device not in alignment with an axis of said positioner.

12. The method of claim 11 wherein said alignment is between 5 and 25 degrees with respect to said axis.

13. The method of claim 11 wherein said alignment is between 5 and 25 degrees with respect to the perpendicular to said axis.

14. The method of claim 1 wherein said holder is positioned in a TEM device.

15. The method of claim 14 wherein said TEM device includes a FIB for thinning said sample.

16. The method of claim 1 wherein said holder includes an opening into which said sample is inserted.

17. The method of claim 16 wherein said opening permits inspection through said sample.

18. The method of claim 17 wherein said holder sandwiches a portion of said sample.
